(19) United States
(12) Patent Application Publication
(10) Pub. No.: US 2012/0288609 A1
(43) Pub. Date: Nov. 15, 2012

(54) GREEN TEA BEVERAGE PACKED IN A CONTAINER

(75) Inventors: Masami Sasame, Makinohara-shi (JP); Hitoshi Kinugasa, Makinohara-shi (JP); Kenji Shimaoka, Makinohara-shi (JP); Takashi Soeda, Makinohara-shi (JP)

(73) Assignee: ITO En, Ltd., Tokyo (JP)

(21) Appl. No.: 13/574,529

(22) PCT Filed: Dec. 22, 2010
(86) PCT No.: PCT/JP2010/073106

§ 371 Date: Jul. 20, 2012

(30) Foreign Application Priority Data
Jan. 29, 2010 (JP) 2010-019137

(51) Int. Cl. A23F 3/00; A23F 3/38

(52) U.S. Cl. 426/597

(57) ABSTRACT

Provided is a caffeine-reduced green tea beverage packed in a container which can be enjoyed either hot or cold, and which has a sweet aroma and rich full-bodied flavor. The green tea beverage packed in a container has a caffeine concentration of less than 90 ppm, and a total sugar concentration (obtained by adding the concentration of nonreducing sugars and the concentration of reducing sugars) that falls within the range of 150 ppm to 500 ppm; a ratio of the concentration of nonreducing sugars to the concentration of reducing sugars (non-reducing sugars/reducing sugars) that falls within the range of 2.0 to 13.0; a ratio of ester catechins to sugar concentration (ester catechins/sugars) that falls within the range of 0.9 to 2.2; and a percentage of the concentration of theanine to the concentration of caffeine (theanine/caffeine×100) of at least 10.0.

### TECHNICAL FIELD

The present invention relates to a green tea beverage packed in a container that contains an extraction liquid of a green tea, which is extracted from green tea leaves as a major component and is filled into a plastic bottle or a can or the like.

### BACKGROUND ART

A green tea beverage is drunk not only to quench the thirst, but in recent years, from the viewpoint of advance of health on the focus of physiological actions of catechins or the like contained in a green tea.

However, a green tea beverage contains caffeine, which is known to have excitatory action or the like, and cause headache, insomnia or the like. Particularly, in the case where a green tea beverage is ingested by infants, old people, pregnant women or the like, there may be a concern of influence of caffeine on them.

Therefore, a green tea beverage having reduced content of caffeine attracts attention in recent years.

For example, Patent Document 1 discloses a tea beverage, which is characterized by containing tannin and caffeine, and having the ratio of the tannin content/the caffeine content being 30 or more.

Patent Document 2 discloses a beverage, which contains (A) an ester type catechin, (B) a free type catechin, and (C) caffeine, wherein the contents are:

(A)+(B)=500 to 6000 mg (I)

(A)/[(A)+(B)]=0.7 to 1.0 (II)

(A)/(C)=6 to 27. (III)

Patent Document 3 discloses a food and drink, which is characterized by containing caffeine in an amount of 0.1 weight part or less, and containing cyclodextrin in an amount of 0.1 to 20.0 weight parts with respect to 1 weight part of catechins.

### CITATION LIST

### Patent Document

Patent Document 1: Japanese Patent Application Laid-Open (JP-A) No. 2008-113569
Patent Document 2: JP-A No. 2006-67828
Patent Document 3: JP-A No. 10-4919

### DISCLOSURE OF THE INVENTION

### Problem to be Solved by the Invention

Under the circumstances where a green tea beverage packed in a container has been popularized, the inventors earnestly studied a beverage that has unique taste and odor. As a result, the inventors found out that adjustments to certain conditions of the concentration of sugars which is a sum of monosaccharides and disaccharides, the ratio of the concentration of disaccharides relative to the concentration of monosaccharides, the ratio of electron-localized catechins relative to the concentration of sugars, and the content ratio of furfural relative to geraniol in aroma components, provide a beverage packed in a container that has spreading odor and residual afterglow of a green tea beverage in the mouth, and richness and concentration feeling in the taste (Japanese Patent Application No. 2009-47421). On the other hand, in recent years, along with diversification of drink scene or the like, low caffeine tea beverage was demanded. However, if the content of caffeine is reduced, there is a problem that components involved in bitter astringent taste are reduced, and concentration feeling is barely sensed.

The inventors further earnestly studied, and found out that by mainly adjusting the ratio of theanine relative to caffeine, it is possible to adjust balances of astringent taste and delicious taste, and bitter astringent taste and delicious taste, and it is possible to provide a beverage that has concentration feeling from sweet scent, and has sweet taste and concentration feeling of sweet and delicious taste even when caffeine is reduced in a green tea beverage packed in a container.

Therefore, the invention provides a caffeine amount-reduced green tea beverage packed in a container that has sweet scent, and has residual sweet taste and richness of delicious taste, and particularly can be drunk delectably even in a cold state by mainly adjusting a balance of sugars that sense sweet taste, and theanine that senses delicious taste.

### Means for Solving Problem

The packaged green-tea of the invention is characterized by having the concentration of caffeine being 90 ppm or less; the concentration of sugars which is a sum of reducing sugars and non-reducing sugars being 150 ppm to 500 ppm; and the ratio of the concentration of non-reducing sugars relative to the concentration of reducing sugars (non-reducing sugars/reducing sugars) being 2.0 to 13.0; the ratio of the concentration of ester type catechins relative to the concentration of sugars (ester type catechins/sugars) being 0.9 to 2.2; and the percentage of concentration of theanine relative to the concentration of caffeine ((theanine/caffeine)×100) being 10.0 or more.

As described above, adjustments of the concentration of sugars which is a sum of reducing sugars and non-reducing sugars, the concentration ratio of reducing sugars and non-reducing sugars, the concentration ratio of ester type catechins and sugars, and the concentration ratio of caffeine and theanine, allow a new green tea beverage packed in a container that has sweet scent, residual richness of sweet taste and delicious taste, and particularly can be drunk delectably even in a cold state.

### BEST MODE(S) FOR CARRYING OUT THE INVENTION

Hereinafter, one illustrative embodiment of the green tea beverage packed in a container of the present invention will be explained. However, the present invention is not limited to this illustrative embodiment.

The present green tea beverage packed in a container is a beverage obtained by filling a liquid containing an extraction liquid or an extract that is obtained by extraction of a green tea as a major component, into a container. The liquid includes, for example, a liquid that comprises only an extraction liquid that is obtained by extraction of a green tea, or a liquid obtained by dilution of the extraction liquid, or a liquid obtained by mixing of the tea extraction liquids with each other, or a liquid obtained by addition of an additive to any of the above-mentioned liquids, or a liquid obtained by dispersion of those dried of any of the above-mentioned liquids and the like.

The “major component” encompasses a meaning that containing of other components is acceptable within a range of not impeding the functions of the major component. At this time, the content ratio of the major component is not specified, but an extraction liquid or an extract that is obtained by extraction of a green tea, preferably takes up 50% by mass or more, particularly 70% by mass or more, and particularly 80% by mass or more (including 100%) in the solid content concentration in the beverage.

In addition, the kind of the green tea is not particularly limited. For example, the kind of the green tea includes broadly teas that are classified as a non-fermented tea such as a steamed tea, a decocted tea, a refined green tea, a green powdered tea, a Bancha tea, a bead green tea, an oven-roasted tea, a Chinese green tea, and also encompasses a blend thereof in two kinds or more. In addition, cereals such as a brown rice, a flavor such as jasmine may be also added thereto.

One illustrative embodiment of the green tea beverage packed in a container of the invention (referred to as “the present green tea beverage packed in a container”) is characterized by the concentration of caffeine being 90 ppm or less; the concentration of sugars which is a sum of reducing sugars and non-reducing sugars being 150 ppm to 500 ppm; the ratio of the concentration of non-reducing sugars relative to the concentration of reducing sugars (non-reducing sugars/reducing sugars) being 2.0 to 13.0; the ratio of the concentration of ester type catechins relative to the concentration of sugars (ester type catechins/sugars) being 0.9 to 2.2; and the percentage of concentration of theanine relative to the concentration of caffeine ((theanine/caffeine)×100) being 10.0 or more.

The reducing sugar is a sugar that shows reducing character, and forms an aldehyde group and a ketone group in an alkaline solution. The reducing sugar referred to in the present invention is glucose, fructose, cellobiose or maltose.

The non-reducing sugar is a sugar that does not show reducing character, and the non-reducing sugar referred to in the present invention represents sucrose, stachyose, or raffinose.

The concentration of sugars which is a sum of reducing sugars and non-reducing sugars (hereinafter, referred to as the concentration of sugars.) being 150 ppm to 500 ppm, allows a beverage that has a balance of taste and odor being maintained, and has sweet taste and richness, and has small bitter astringent taste, coarse taste, and the like in the aftertaste even in drinking in a state stored for a long period at room temperature, or in a cold state.

From such viewpoint, the concentration of sugars is preferably 170 ppm to 400 ppm, particularly preferably 180 ppm to 300 ppm.

In adjustment of the concentration of sugars to the above-described range, if dry (firing) process or extraction of tea leaves may be adjusted to suitable conditions. For example, dry (firing) process of tea leaves is performed strongly, sugars are decomposed and decrease. In addition, if the tea leaves are extracted at high temperature for a long time, the sugars are decomposed and decrease. Therefore, the concentration of sugars may be adjusted by dry (firing) conditions and extraction conditions of tea leaves.

Although the adjustment may be performed by addition of sugars, this has a fear of collapsing the balance of a green tea beverage, so the adjustment is preferably not by addition of sugars, but by adjustment of conditions for obtaining a tea extraction liquid, and in addition, by mixing of the tea extraction liquids with each other, or by addition of a tea extract, or the like.

In addition, when the ratio of the concentration of non-reducing sugars relative to the concentration of reducing sugars (non-reducing sugars/reducing sugars) being 2.0 to 13.0, it allows a beverage that has sweet taste of fire odor when the green tea beverage is put into the mouth, spreads in the mouth and remains during going down one's throat come to have moderate concentration feeling, and has flavor and robust feel.

From such viewpoint, the ratio of the concentration of non-reducing sugars relative to the concentration of reducing sugars (non-reducing sugars/reducing sugars) is preferably 2.5 to 12.0, and particularly preferably 4.0 to 12.0.

In adjustment of the ratio of the concentration of non-reducing sugars relative to the concentration of reducing sugars, to the above-described range, dry (firing) process or extraction of tea leaves may be adjusted to suitable conditions. For example, if dry (firing) process of tea leaves is performed, reducing sugars decrease first, and then non-reducing sugars decrease. Thus, by performing dry (firing) process of tea leaves and extracting the tea leaves at low temperature for a long time, it is possible to reduce the ratio of non-reducing sugars/reducing sugars.

Although the adjustment may be performed by addition of sugars, this has a fear of collapsing the balance of a green tea beverage, so the adjustment is preferably performed not by addition of sugars, but by adjustment of conditions for obtaining a tea extraction liquid, and in addition, by mixing of the tea extraction liquids with each other, by addition of a tea extract, or the like.

The concentration of total catechins in the present green tea beverage packed in a container is preferably 270 ppm to 920 ppm.

The concentration of total catechins is more preferably 300 ppm to 850 ppm, and particularly preferably 350 ppm to 850 ppm.

Furthermore, the total catechins means total 8 kinds of catechins (C), gallocatechins (GC), catechins gallate (Cg), gallocatechins gallate (GCg), epicatechins (EC), epigallocatechins (EGC), epicatechins gallate (ECg), and epigallocatechins gallate (EGCg), and the concentration of the total catechins means total values of the concentrations of the 8 kind catechins.

In adjustment of the concentration of total catechins to the above-described range, extraction conditions or the like may be adjusted. Although the adjustment may be performed by addition of catechins, this has a fear of collapsing the balance of a green tea beverage, so the adjustment is preferably performed by adjustment of conditions for obtaining a tea extraction liquid, and in addition, by mixing of the tea extraction liquids with each other, by addition of a tea extract, or the like.

The concentration of ester type catechins in the present green tea beverage packed in a container is preferably 135 ppm to 560 ppm.

The concentration of ester type catechins is more preferably 175 ppm to 525 ppm, and particularly preferably 200 ppm to 475 ppm.

Furthermore, the “ester type catechins” means total four kinds of epigallocatechins gallate (EGCg), gallocatechins gallate (GCg), epicatechins gallate (ECg), and catechins gallate (Cg).

In adjustment of the concentration of ester type catechins to the above-described range, extraction conditions or the like may be adjusted. However, if the temperature is too high, or the extraction time is too long, it is not preferable in view of holding scent balance of a beverage. Although the adjustment may be performed by addition of ester type catechins, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The ratio of the concentration of ester type catechins relative to the concentration of sugars (ester type catechins/sugars) in the present green tea beverage packed in a container is 0.9 to 2.2. When the ratio is within this range, it allows a beverage that has a balance of astringent taste and sweet taste being maintained, and also can sense sweet taste of fire odor, and has richness and concentration feeling in the taste, and has deep delicious taste.

From such viewpoint, the ratio of the concentration of ester type catechins relative to the concentration of sugars (ester type catechins/sugars) is preferably 1.2 to 2.0, and particularly preferably 1.4 to 1.8.

In adjustment of the ratio of the concentration of ester type catechins relative to the concentration of sugars to the above-described range, extraction conditions or the like may be adjusted. However, although the extraction rate of catechins increases at high temperature, sugars are likely to be decomposed, and thus the extraction time is preferably short. Although the adjustment may be performed by addition of ester type catechins and sugars, this has a fear of collapse of the balance of a green tea beverage, so the adjustment is preferably performed by adjustment of conditions for obtaining a tea extraction liquid, and in addition, by mixing of the tea extraction liquids with each other, or by addition of a tea extract, or the like.

The percentage of concentration of theanine relative to the concentration of caffeine ((theanine/caffeine)×100) in the present green tea beverage packed in a container is 10.0 or more. When the ratio is within this range, it allows a beverage that has a balance of delicious taste and bitter astringent taste being maintained, and has concentration feeling from delicious taste, and robust feel.

From such viewpoint, the percentage of concentration of theanine relative to the concentration of caffeine ((theanine/caffeine)×100) is preferably 12.0 to 1000, and particularly preferably 15.0 to 800.

Furthermore, the theanine is a derivative of glutamic acid contained in a green tea or the like, and includes, for example, L- or D-glutamic acid-γ-alkyl amide such as L-glutamic acid-γ-ethyl amide (L-theanine), L-glutamic acid-γ-methyl amide, D-glutamic acid-γ-ethyl amide (D-theanine), D-glutamic acid-γ-methyl amide, or a derivative containing the L- or D-glutamic acid-γ-alkyl amide in the basic structure (for example, glycoside of L- or D-glutamic acid-γ-alkyl amide and the like), and the like.

In adjustment of the percentage of concentration of theanine relative to the concentration of caffeine, to the above-described range, the percentage may be adjusted with strong dry conditions for raw materials. Although the adjustment may be performed by addition of theanine, this has a fear of collapsing the balance of a green tea beverage, so the adjustment is preferably performed by adjustment of conditions for obtaining a tea extraction liquid, and in addition, by mixing of the tea extraction liquids with each other, by addition of a tea extract, or the like.

The concentration of theanine in the present green tea beverage packed in a container is preferably 8.0 ppm or more. When the ratio is within this range, it allows a beverage that has odor spreading in the mouth even at a low temperature, also has odor remaining during going down one's throat, and has delicious taste and robust feel, and has a balance of taste and odor.

From such viewpoint, the concentration of theanine is more preferably 10.0 ppm to 250 ppm, and particularly preferably 12.0 ppm to 250 ppm.

In adjustment of the concentration of theanine to the above-described range, the concentration of theanine may be adjusted with selection of raw materials, conditions of dry (firing) process of tea leaves in consideration of a point of easy decomposition at high temperature, or the like. Although the adjustment may be performed by addition of theanine, this has a fear of collapsing the balance of a green tea beverage, so the adjustment is preferably performed by adjustment of conditions for obtaining a tea extraction liquid, and in addition, by mixing of the tea extraction liquids with each other, by addition of a tea extract, or the like.

The concentration of caffeine in the present green tea beverage packed in a container is preferably 90 ppm or less.

Caffeine is contained in 110 ppm to 250 ppm in a conventional green tea beverage packed in a container. However, the caffeine amount set to less than 90 ppm alleviates a physiological influence on a person.

From such viewpoint, the concentration of caffeine is preferably 5 ppm to 85 ppm, and particularly preferably 10 ppm to 70 ppm.

In adjustment of the concentration of caffeine to the above-described range, the concentration of caffeine may be adjusted by blowing hot water to tea leaves, or immersing tea leaves in hot water to elute caffeine in the tea leaves, and prepare tea extraction liquids using the tea leaves, and mix the tea extraction liquids with each other. In addition, the extraction liquid may be subjected to an adsorbent such as activated carbon and white clay, whereby to adsorb and remove caffeine.

In addition, the ratio of the concentration of total catechins relative to the concentration of caffeine in the present green tea beverage packed in a container (total catechins/caffeine) is preferably 3.0 to 900.

The ratio of the concentration of total catechins relative to the concentration of caffeine is more preferably 3.2 to 800, and particularly preferably 3.5 to 800.

In adjustment of the ratio of the concentration of total catechins relative to the concentration of caffeine to the above-described range, the ratio may be adjusted with the above-described caffeine reducing treatment, the amount of tea leaves, extraction temperature, or the like. Although the adjustment may be performed by addition of total catechins, this has a fear of collapsing the balance of a green tea beverage, so the adjustment is preferably performed by adjustment of conditions for obtaining a tea extraction liquid, and in addition, by mixing of the tea extraction liquids with each other, by addition of a tea extract, or the like.

The concentration of the soluble solid content derived from the tea leaves in the present green tea beverage packed in a container is preferably 0.18 to 0.40%. Furthermore, the soluble solid content derived from the tea leaves refers to a sucrose-converted value of the soluble solid content obtained by extraction of the green tea leaves.

The soluble solid content derived from the tea leaves in the present green tea beverage packed in a container is more preferably 0.19 to 0.38%, and particularly preferably 0.20 to 0.35%.

In adjustment of the soluble solid content derived from the tea leaves to the above-described range, the soluble solid content may be suitably adjusted with the amount of tea leaves and extraction conditions.

The ratio of the concentration of sugars relative to the concentration of the soluble solid content derived from tea leaves (sugars/(the soluble solid content derived from the tea leaves×100)) in the present green tea beverage packed in a container is preferably 3.5 to 25.0. When the ratio is within this range, it allows a beverage that suitably maintains richness in the taste and concentration feeling relative to astringent taste or the like, and has balance with the odor, and has deep taste.

From such viewpoint, the ratio of the concentration of sugars relative to the soluble solid content derived from tea leaves is more preferably 3.8 to 23.0, and particularly preferably 4.0 to 20.0.

In adjustment of the ratio of the concentration of sugars relative to the concentration of the soluble solid content derived from tea leaves to the above-described range, the concentration of the solid content may be elevated by increasing the amount of tea leaves, and the ratio may be adjusted with combination of the amount of tea leaves and roasting conditions for the raw tea. Although the adjustment may be performed by addition of the sugars, this has a fear of collapsing the balance of a green tea beverage, so the adjustment is preferably performed by adjustment of conditions for obtaining a tea extraction liquid, and in addition, by mixing of the tea extraction liquids with each other, by addition of a tea extract, or the like.

The ratio of the concentration of ester type catechins relative to the concentration of the soluble solid content derived from tea leaves (ester type catechins/(the soluble solid content derived from the tea leaves×100)) in the present green tea beverage packed in a container is preferably 3.4 to 30.0. When the ratio is within this range, it allows a beverage that can suitably maintain concentration feeling from astringent taste relative to sweet taste or the like, and has a balance of odor afterglow and the concentration feeling of the taste, and further is also stable in the aspect over time.

From such viewpoint, the ratio of the concentration of ester type catechins relative to the concentration of the soluble solid content derived from tea leaves is more preferably 3.6 to 28.0, and particularly preferably 3.8 to 25.0.

In adjustment of the ratio of the concentration of ester type catechins relative to the concentration of the soluble solid content derived from tea leaves to the above-described range, the adjustment may be performed with extraction conditions or the like since the dissolution properties of catechins are different to each other depending on the extraction temperature. Although the adjustment may be performed by addition of the sugars, this has a fear of collapsing the balance of a green tea beverage, so the adjustment is preferably by adjustment of conditions for obtaining a tea extraction liquid, and in addition, by mixing of the tea extraction liquids with each other, by addition of a tea extract, or the like.

The ratio of the concentration of total catechins relative to the concentration of the soluble solid content derived from tea leaves (total catechins/(the soluble solid content derived from the tea leaves×100)) in the present green tea beverage packed in a container is preferably 6.8 to 50.0.

The ratio of the concentration of total catechins relative to the concentration of the soluble solid content derived from tea leaves is more preferably 7.0 to 48.0, and particularly preferably 8.0 to 45.0.

In adjustment of the ratio of the concentration of total catechins relative to the concentration of the soluble solid content derived from tea leaves to the above-described range, the ratio may be adjusted with dry conditions and extraction conditions of tea leaves. Although the adjustment may be performed by addition of catechins, this has a fear of collapsing the balance of a green tea beverage, so the adjustment is preferably performed by adjustment of conditions for obtaining a tea extraction liquid, and in addition, by mixing of the tea extraction liquids with each other, by addition of a tea extract, or the like.

The pH in the present green tea beverage packed in a container is preferably 5.5 to 6.5 at 20° C. The pH in the present green tea beverage packed in a container is more preferably 5.8 to 6.4, and particularly preferably 5.9 to 6.3.

In adjustment of the pH to the above-described range, for example, the pH may be adjusted with the amount of a pH adjusting agent such as ascorbic acid and sodium bicarbonate.

The concentration of the above-described reducing sugars, non-reducing sugars, total catechins, ester type catechins, caffeine, and theanine, can be measured by a calibration curve method or the like using high performance liquid chromatogram (HPLC) or the like, and the concentration of the soluble solid content derived from tea leaves described above can be measured by a differential concentration meter.

(Container)

A container to be filled with the present green tea beverage packed in a container is not particularly limited. For example, a plastic-made bottle (so-called PET bottle), a can of metal such as steel and aluminum, a bottle, a paper container may be used, and particularly, a transparent container such as a PET bottle may be preferably used as the container.

(Manufacturing Method)

The present green tea beverage packed in a container may be manufactured by, for example, selecting raw materials for tea leaves; suitably adjusting conditions for dry (firing) process and extraction for the tea leaves; adjusting the concentration of caffeine in the beverage to 90 ppm or less; adjusting the concentration of sugars which is a sum of reducing sugars and non-reducing sugars to 150 ppm to 500 ppm; adjusting the ratio of the concentration of non-reducing sugars relative to the concentration of reducing sugars (non-reducing sugars/reducing sugars) to 2.0 to 13.0; adjusting the ratio of the concentration of ester type catechins relative to the concentration of sugars (ester type catechins/sugars) to 0.9 to 2.2; and adjusting the percentage of concentration of theanine relative to the concentration of caffeine (theanine/caffeine×100) to 10.0 or more.

For example, the present green tea beverage packed in a container may be manufactured by preparing an extraction liquid, which is obtained by blowing hot water shower of 70° C. to 100° C. to tea leaves for 60 to 180 seconds to elute caffeine, and subjecting the tea leaves to a dry (firing) process at 220° C. to 270° C., and extracting the tea leaves at high temperature for a short time; an extraction liquid, which is obtained by preparing a conventional general green tea extraction liquid, that is, an extraction liquid that is obtained by subjecting tea leaves to a dry (firing) process at 80° C. to 150° C. and extracting the tea leaves at low temperature for a long time; and blending the extraction liquids in a suitable ratio. However, the manufacturing method is not limited to such manufacturing method.

Furthermore, as described above, by performing the dry process of tea leaves, reducing sugars decrease first, and then non-reducing sugars decrease. Therefore, the concentration of sugars and the value of non-reducing sugars/reducing sugars may be adjusted with adjustment of conditions for dry process.

(Explanation for Terms)

The “green tea beverage” in the present invention means a beverage containing a tea extraction liquid or tea extract that is obtained from tea extraction, as a major component.

In addition, the “green tea beverage packed in a container” means a green tea beverage that is packaged in a container, and also means a green tea beverage that may be provided for drinking without dilution.

When “X to Y” (X and Y are any number) is expressed in the present specification, it encompasses the meaning of “X or more and Y or less”, and also the meaning of “preferably greater than X” and “preferably less than Y” unless otherwise stated.

### EXAMPLES

Hereinafter, Examples of the present invention will be explained. However, the present invention is not limited to these Examples.

Furthermore, the “concentration of reducing sugars” in Examples means a total concentration of glucose, fructose, cellobiose, and maltose, and the “concentration of non-reducing sugars” means a total concentration of sucrose, stachyose, and raffinose.

<<Evaluation Test 1>>

Extraction Liquids A to H described below were prepared, and using these Extraction Liquids, tea beverages of Examples 1 to 6 and Comparative Examples 1 to 4 were prepared, and sensory evaluations therefor were performed.

(Extraction Liquid A)

Tea leaves (Yabukita species, first flush tea produced in Shizuoka Prefecture) after plucking were subjected to Aracha process, and to a dry process (firing process) under the conditions of 90° C. of the setting temperature and 30 minutes of the dry time with a rotation drum type drying machine. The tea leaves were extracted under the conditions of 10 g of the tea leaves, 1 L of 55° C. warm water and 8 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid A.

(Extraction Liquid B)

Tea leaves (Yabukita species, first flush tea produced in Shizuoka Prefecture) after plucking were subjected to Aracha process, and to a dry process (firing process) under the conditions of 270° C. of the setting temperature and 15 minutes of the dry time with a rotation drum type drying machine. The tea leaves were extracted under the conditions of 8 g of the tea leaves, 1 L of 90° C. hot water and 6 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid B.

(Extraction Liquid C)

Tea leaves (Yabukita species, first flush tea produced in Shizuoka Prefecture) after plucking were subjected to Aracha process, and to a dry process (firing process) under the conditions of 220° C. of the setting temperature and 15 minutes of the dry time with a rotation drum type drying machine. The tea leaves were extracted under the conditions of 11 g of the tea leaves, 1 L of 90° C. hot water, and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid C.

(Extraction Liquid D)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 90° C. of the setting temperature and 30 minutes of the dry time with a rotation drum type drying machine. The tea leaves were extracted under the conditions of 10 g of the tea leaves, 1 L of 55° C. warm water, and 8 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction liquid D.

(Extraction Liquid E)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 240° C. of the setting temperature and 20 minutes of the dry time with a rotation drum type drying machine. The tea leaves were extracted under the conditions of 10 g of the tea leaves, 1 L of 90° C. hot water, and 12 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid E.

(Extraction Liquid F)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 270° C. of the setting temperature and 15 minutes of the dry time with a rotation drum type drying machine. The tea leaves were extracted under the conditions of 10 g of the tea leaves, 1 L of 90° C. hot water, and 12 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid F.

(Extraction Liquid G)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 220° C. of the setting temperature and 15 minutes of the dry time with a rotation drum type drying machine. The tea leaves were extracted under the conditions of 11 g of the tea leaves, 1 L of 90° C. hot water, and 7 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid G.

(Extraction Liquid H)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (firing process) under the conditions of 110° C. of the setting temperature and 20 minutes of the dry time with a rotation drum type drying machine. The tea leaves were extracted under the conditions of 10 g of the tea leaves, 1 L of 90° C. hot water, and 6 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction liquid H.

(Analysis of Extraction Liquids)

1/10 amount of each the above-described an extraction liquids was weighed, added with ascorbic acid in 400 ppm, and then added with sodium bicarbonate to adjust pH to 6.2, and added with ion-exchanged water to adjust the total amount to 100 mL. This liquid was filled into a heat-resistant transparent container (bottle) and capped, and over-turn sterilized for 30 seconds. The sterilization was performed to 9 or more of Fₒ value for retort sterilization (121° C., 9 minutes), and the solution was immediately cooled to 20° C. and measured for analysis of the components of each extraction liquid.

The results of the analyses are presented in Table 1 described below. Furthermore, the measurement method is as described below.

TABLE 1

| | | | | | | | [symbol] solid | | | | |
|---|---|---|---|---|---|---|---|---|---|---|---|
| | | | | | | | content | | | | |
| | [symbol] | | [symbol] type | | | Total | derived from | | Extraction | Extraction | Amount of tea |
| | [symbol] | [symbol] | [symbol] | [symbol] | [symbol] | [symbol] | [symbol] | Heating | Temperature | time | [symbol] used |
| | [symbol] | (ppm) | (ppm) | (ppm) | (ppm) | (ppm) | (%) | [symbol] | (° C.) | (minutes) | (g/l) |
| Extraction | 1.18 | 282.3 | 241.00 | 157.3 | 42.30 | 491.9 | 9.282 | Fixing at 90° C. | 55 | 8 | 10 |
| Liquid A | | | | | | | | for 30 minutes | | | |
| Extraction | 15.32 | 158.6 | 165.30 | 145.4 | 18.40 | 356.4 | 0.224 | Fixing at | 50 | 6 | 6 |
| Liquid B | | | | | | | | 270° C. for 15 | | | |
| | | | | | | | | minutes | | | |
| Extraction | 2.58 | 227.8 | 436.20 | 237.5 | 263.40 | 873.4 | 0.011 | Fixing at | 99 | 3.5 | 11 |
| Liquid C | | | | | | | | 220° C. for 15 | | | |
| | | | | | | | | minutes | | | |
| Extraction | 1.98 | 229.7 | 220.80 | 55.4 | 48.90 | 445.4 | 9.254 | Fixing at 90° C. | 55 | 8 | 18 |
| Liquid D | | | | | | | | for 10 minutes | | | |
| Extraction | 13.58 | 142.8 | 289.12 | 63.8 | 5.99 | 258.2 | 0.241 | Fixing at | 90 | 12 | 10 |
| Liquid E | | | | | | | | 240° C. for 20 | | | |
| | | | | | | | | minutes | | | |
| Extraction | 16.55 | 157.3 | 156.20 | 47.4 | 16.60 | 302.6 | 0.196 | Fixing at | 99 | 12 | 10 |
| Liquid F | | | | | | | | 270° C. for 15 | | | |
| | | | | | | | | minutes | | | |
| Extraction | 2.79 | 224.5 | 293.00 | 43.1 | 22.90 | 286.1 | [symbol] | Fixing at | 90 | [symbol] | 11 |
| Liquid G | | | | | | | | 220° C. for 15 | | | |
| | | | | | | | | minutes | | | |
| Extraction | 3.51 | 147.7 | 379.38 | 69.4 | 48.39 | 678.9 | 5.331 | Fixing at | 90 | 6 | 10 |
| Liquid H | | | | | | | | 110° C. for 20 | | | |
| | | | | | | | | minutes | | | |

[symbol]

indicates data missing or illegible when filed

(Blending)

Extraction Liquids A to H were blended in the ratios presented in Table 2 described below, added with ascorbic acid in 400 ppm, and then added with sodium bicarbonate to suitably adjust the pH, and added with ion-exchanged water to adjust the total amount to 1000 mL. This liquid was filled into a heat-resistant transparent container (bottle) and capped, and over-turn sterilized for 30 seconds. The sterilization was performed to 9 or more of Fₒ value for retort sterilization (121° C., 9 minutes), and the solution was immediately cooled to 20° C., to prepare the green tea beverages of Examples 1 to 6 and Comparative Examples 1 to 4.

TABLE 2

| | | | | | | | Comparative | Comparative | Comparative | Comparative |
|---|---|---|---|---|---|---|---|---|---|---|
| | Example 1 | Example 2 | Example 3 | Example 4 | Example 5 | Example 6 | Example 1 | Example 2 | Example 3 | Example 4 |
| Extraction | 20 | 0 | 0 | 0 | 0 | | 0 | 0 | 0 | 0 |
| Liquid A | | | | | | | | | | |
| Extraction | 0 | 30 | 0 | 0 | 0 | 0 | 0 | 0 | 0 | 0 |
| Liquid B | | | | | | | | | | |
| Extraction | 0 | 0 | 0 | 0 | 0 | 0 | 0 | 0 | 10 | 0 |
| Liquid C | | | | | | | | | | |
| Extraction | 0 | 70 | 40 | 0 | 10 | 0 | 100 | 0 | 0 | 0 |
| Liquid D | | | | | | | | | | |
| Extraction | 80 | 0 | 0 | 0 | 90 | 90 | 0 | 0 | 90 | 0 |
| Liquid E | | | | | | | | | | |
| Extraction | 0 | 0 | 60 | 0 | 0 | 0 | 0 | 100 | 0 | 0 |
| Liquid F | | | | | | | | | | |
| Extraction | 0 | 0 | 0 | 100 | 0 | 10 | 0 | 0 | 0 | 0 |
| Liquid G | | | | | | | | | | |
| Extraction | 0 | 0 | 0 | 0 | 0 | 0 | 0 | 0 | 0 | 100 |
| Liquid H | | | | | | | | | | |
| total | 100 | 100 | 100 | 100 | 100 | | 100 | 100 | 100 | 100 |

(Analysis of Examples and Comparative Examples)

Components and pH of the green tea beverages of Examples 1 to 6 and Comparative Examples 1 to 4 were measured as presented below. The results are presented in Table 3 described below.

TABLE 3

| | | | | | | | | Com- | Com- | Com- | Com- |
|---|---|---|---|---|---|---|---|---|---|---|---|
| | | | | | | | | parative | parative | parative | parative |
| | | Example 1 | Example 2 | Example 3 | Example 4 | Example 5 | Example 6 | Example 1 | Example 2 | Example 3 | Example 4 |
| [symbol] | | 120.7 | 243.4 | 256.3 | 224.5 | 156.5 | 151.6 | 279.1 | 187.1 | 151.3 | 167.7 |
| Non-inducing Sugar/Reducing | | 11.40 | 5.97 | 10.71 | 2.78 | 12.62 | 12.20 | 1.96 | 16.55 | 12.68 | 3.51 |
| Sugar | | | | | | | | | | | |
| [symbol] type [symbol] | | 1.57 | 0.91 | 0.92 | 1.75 | 1.63 | 1.25 | 0.80 | 1.00 | 1.76 | 2.26 |
| [symbol] type [symbol] (ppm) | | 248.8 | 211.6 | 183.1 | 293.0 | 246.5 | 262.5 | 222.8 | 156.7 | 267.5 | 379.3 |
| caffiene (ppm) | | 52.5 | 82.4 | 58.6 | 83.1 | 63.0 | 65.2 | 55.6 | 42.4 | 81.2 | 89.4 |
| [symbol] (ppm) | | 13.22 | 36.75 | 29.52 | 23.55 | 10.25 | 7.25 | 48.90 | 16.60 | 8.30 | 45.20 |
| [symbol] (80° C.) | | 3.8 | 6.2 | 6.2 | 6.2 | 6.2 | 6.2 | 6.2 | 6.2 | 6.2 | 6.2 |
| Total [symbol] (ppm) | | 497.5 | 218.7 | 339.8 | 786.1 | 492.9 | 327.0 | [symbol] | 300.7 | 535.2 | 675.3 |
| Soluble solid content | | 0.25 | 0.25 | 0.22 | 0.37 | 0.24 | 0.15 | 0.25 | 0.20 | 0.16 | 0.33 |
| derived from tea [symbol] (%) | | | | | | | | | | | |
| [symbol] | | 16.02 | 88.24 | 58.24 | 28.16 | 16.27 | 11.78 | 88.27 | 35.02 | 5.65 | 69.48 |
| [symbol] | [symbol] | ◯ | ◯ | ◯ | ◯ | ◯ | ◯ | ◯ | ◯ | ◯ | ◯ |
| | tea [symbol] | | | | | | | | | | |
| | [symbol] | ⊚ | ◯ | ⊚ | ◯ | ⊚ | ⊚ | Δ | ◯ | Δ | ◯ |
| | [symbol] | | | | | | | | | | |
| | [symbol] | | | | | | | | | | |
| [symbol] | [symbol] | ◯ | ⊚ | ⊚ | ⊚ | ◯ | ◯ | Δ | Δ | Δ | Δ |
| | [symbol] | | | | | | | | | | |
| | Delicious taste | ◯ | ⊚ | ⊚ | ◯ | ◯ | ◯ | ⊚ | Δ | Δ | ◯ |

| | | | | | | | | | | |
|---|---|---|---|---|---|---|---|---|---|---|
| [symbol] | ◯ | ◯ | ⊚ | ◯ | ◯ | ◯ | Δ | Δ | Δ | Δ |
| [symbol] | | | | | | | | | | |
| [symbol] | ◯ | ◯ | ◯ | ◯ | ◯ | ◯ | Δ | Δ | Δ | Δ |

[symbol]

indicates data missing or illegible when filed

The concentration of reducing sugars and the concentration of non-reducing sugars were quantity-measured by a calibration curve method with manipulation of a HPLC sugar analysis equipment (manufactured by Dionex Corporation) under the conditions described below.

Column: Carbopack PA1 φ4.6×250 mm manufactured by Dionex Corporation

Column temperature: 30° C.

Mobile Phase:
Phase A 200 mM NaOH
Phase B 1000 mM Sodium Acetate
Phase C Ultrapure water

Flow Rate: 1.0 mL/min

Injection Amount: 50 μL

Detection: ED50 gold electrode manufactured by Dionex Corporation

The concentration of ester type catechins, the concentration of total catechins, the concentration of caffeine, and the concentration of theanine were quantity-measured by a calibration curve method with manipulation of a high performance liquid chromatogram (HPLC) under the conditions described below.

Column: Xbridge shield RP18 φ3.5×150 mm manufactured by Waters Corporation

Column Temperature: 40° C.

Mobile Phase:
Phase A Water
Phase B Acetonitrile
Phase C 1% phosphoric acid

Flow Rate: 0.5 mL/min

Injection Amount: 5 μL

Detection: UV230 nm UV detector manufactured by Waters Corporation

The pH was measured with F-24, a pH meter manufactured by HORIBA, Ltd.

An extraction liquid containing only extract of tea leaves was diluted to 1 L of the liquid amount, and the concentration of the soluble solid content derived from tea leaves was measured with a differential concentration meter DD-7 manufactured by ATAGO CO., Ltd.

(Evaluation Item)

Using the green tea beverages of Examples 1 to 6 and Comparative Examples 1 to 4, the odor (odor spreading in the mouth, the odor remaining during going down one's throat), taste (robust feel (richness), delicious taste), and the palatability (balance of odor and taste) were evaluated.

(Evaluation Test)

The green tea beverages of Examples 1 to 6 and Comparative Examples 1 to 4 (25° C. temperature) were tasted by five persons of trained examiners, and given scores by the standards as described below. The average points of the five persons were evaluated such that “⊚ (double circle)” indicates 3.5 or more, “∘ (circle)” indicates 3 or more and less than 3.5, “Δ (triangle)” indicates 2 or more and less than 3, and “x (cross)” indicates 1 or more and less than 2. The results thereof are presented in Table 3 described above.

<Odor Spreading in the Mouth>

Particularly Strong=4

Strong=3

Usual=2

Week=1

<Odor Remaining During Going Down One's Throat>

Particularly Strong=4

Strong=3

Usual=2

Week=1

<Robust Feel (Richness)>

Strong Concentration=4

Some Concentration=3

Slight Concentration=2

Clean=1

<Delicious Taste>

Particularly Strong=4

Strong=3

Usual=2

Week=1

<Palatability (Balance of Odor and Taste)>

Very likable=4

Likable=3

Usual=2

Dislikable=1

(Total Evaluation)

The average points of the above-described evaluation test were computed, and the evaluations were performed in which “⊚ (double circle)” indicates 3.5 or more, “∘ (circle)” indicates 3 or more and less than 3.5, “Δ (triangle)” indicates 2 or more and less than 3, and “x (cross)” indicates 1 or more and less than 2 of the average point.

For any of Examples 1 to 6, excellent results were obtained, of which the total evaluation was “∘ (circle)” or better.

On the other hand, for Comparative Examples 1 to 4, the results were not preferable, of which the evaluation was “Δ (triangle)”.

From the results of Comparative Examples 1 and 2, it was found out that if the value of non-reducing sugars/reducing sugars decreases, odor and palatability become worse, and if the value of non-reducing sugars/reducing sugars increases, taste and palatability become worse.

From the results of Comparative Examples 1 and 4, it was found out that if the value of ester type catechins/sugars decreases or increases, the richness becomes poor and a balance of odor and taste also collapses, and thus the sensory evaluations become worse totally.

From the results of Comparative Example 3, it was found out that if the value of theanine/caffeine×100 decreases, delicious taste is weak, and richness and odor remaining during going down one's throat are weak, and thus the sensory evaluations become worse totally.

From these results, it is assumed that the ranges of the concentration of caffeine being 90 ppm or less, the concentration of sugars which is a sum of reducing sugars and non-reducing sugars being 150 ppm to 500 ppm, the ratio of the concentration of non-reducing sugars relative to the concentration of reducing sugars (non-reducing sugars/reducing sugars) being 2.0 to 13.0, the ratio of the concentration of ester type catechins relative to the concentration of sugars (ester type catechins/sugars) being 0.9 to 2.2, and the percentage of concentration of theanine relative to the concentration of caffeine ((theanine/caffeine)×100) being 10.0 or more, are ranges that allow a green tea beverage that has good odor (odor spreading in the mouth, odor remaining during going down one's throat), taste (robust feel (richness), delicious taste), and palatability (balance of odor and taste). It was discovered that a green tea beverage having them within such ranges provide a green tea beverage that has sweet scent, and residual sweet taste and richness of delicious taste.

<<Evaluation Test 2>>

Using the green tea beverages of the above-described Examples 1, 3, 5, and 6, evaluation tests were conducted described below.

(Evaluation Test)

The green tea beverages of Examples 1, 3, 5, and 6 were cooled to 5° C. in a refrigerator. Each of the green tea beverages was tasted by five persons of trained examiners, and evaluations were performed as described above. The results thereof are presented in Table 4 described below.

TABLE 4

| | | Example 1 | Example 3 | Example 5 | Example 6 |
|---|---|---|---|---|---|
| Flavor | Odor | ◯ | ◯ | ◯ | ◯ |
| | spreading in | | | | |
| | the mouth | | | | |
| | Odor | ⊚ | ⊚ | ⊚ | ◯ |
| | remaining | | | | |
| | during going | | | | |
| | down one's | | | | |
| | throat | | | | |
| Taste | Robust feel | ◯ | ◯ | ⊚ | Δ |
| | (richness) | | | | |
| | Delicious | Δ | ◯ | Δ | Δ |
| | taste | | | | |

| | | | | |
|---|---|---|---|---|
| Palatability | ◯ | ⊚ | ◯ | ◯ |
| (balance of odor and | | | | |
| taste) | | | | |
| Total Evaluation | ◯ | ⊚ | ◯ | Δ |

(Total Evaluation)

Example 3 had an evaluation of “⊚ (double circle)”, which was a good result.

On the other hand, Example 6 had an evaluation of “Δ (triangle)”, which was a somewhat inferior result.

(Discussion)

It was found out that the total evaluation for Example 3, which had the highest concentration of theanine, was good, whereas the total evaluation for Example 6, which had the lowest concentration of theanine, was somewhat inferior.

From these results, it was discovered that if the concentration of theanine is 8 ppm or more, it allows a caffeine amount-reduced green tea beverage that can be drunk delectably even in a cold state.

1. A green tea beverage packed in a container wherein;
a concentration of caffeine is 90 ppm or less;
a concentration of sugars, a sum of reducing sugars and non-reducing sugars is 150 ppm to 500 ppm;
a ratio of a concentration of non-reducing sugars relative to a concentration of reducing sugars (non-reducing sugars/reducing sugars) is 2.0 to 13.0;
a ratio of a concentration of ester type catechins relative to a concentration of sugars (ester type catechins/sugars) is 0.9 to 2.2; and,
a percentage of concentration of theanine relative to a concentration of caffeine ((theanine/caffeine)×100) is 10.0 or more.

2. The green tea beverage packed in a container according to claim 1 wherein the concentration of theanine is 8 ppm or more.

3. A method of preparing a green tea beverage packed in a container, comprising;
adjusting a concentration of caffeine in a green tea beverage to 90 ppm or less;
adjusting a concentration of sugars, a sum of reducing sugars and non-reducing sugars to 150 ppm to 500 ppm;
adjusting a ratio of a concentration of non-reducing sugars relative to a concentration of reducing sugars (non-reducing sugars/reducing sugars) to 2.0 to 13.0;
adjusting a ratio of a concentration of ester type catechins relative to a concentration of sugars (ester type catechins/sugars) to 0.9 to 2.2; and,
adjusting a percentage of concentration of theanine relative to a concentration of caffeine ((theanine/caffeine)×100) to 10.0 or more.

4. A method of improving a flavor of a green tea beverage packed in a container, comprising;
adjusting a concentration of caffeine in a green tea beverage to 90 ppm or less;
adjusting a concentration of sugars, a sum of reducing sugars and non-reducing sugars to 150 ppm to 500 ppm;
adjusting a ratio of a concentration of non-reducing sugars relative to a concentration of reducing sugars (non-reducing sugars/reducing sugars) to 2.0 to 13.0;
adjusting a ratio of a concentration of ester type catechins relative to a concentration of sugars (ester type catechins/sugars) to 0.9 to 2.2; and,
adjusting a percentage of concentration of theanine relative to a concentration of caffeine ((theanine/caffeine)×100) to 10.0 or more.
